(19) United States
(12) Patent Application Publication
(10) Pub. No.: US 2021/0100358 A1
(43) Pub. Date: Apr. 8, 2021

(54) Interactive Restaurant Table Assembly

(71) Applicant: Lajamieka Mims, Orange, TX (US)

(72) Inventor: Lajamieka Mims, Orange, TX (US)

(21) Appl. No.: 16/591,746

(22) Filed: Oct. 3, 2019

(51) Int. Cl. A47B 37/00; G06F 3/0482; G06F 3/0488; G07F 7/02; E04H 3/04; A47B 13/08

(52) U.S. Cl. CPC A47B 37/00; G06F 3/0482; G06F 3/0488; G06Q 30/06; E04H 3/04; A47B 13/08; G07F 7/025

(57) ABSTRACT

An interactive restaurant table assembly includes a table that is positionable in a restaurant. A plurality of proximity sensors is provided and each of the proximity sensors is coupled to the table. Each of the proximity sensors is turned on when a patron moves within a trigger distance of the proximity sensors. A plurality of touch screens is each of the touch screens is coupled to the table. Each of the touch screens displays menu of the restaurant thereby facilitating the patron to order from the menu. A transceiver is coupled to the table and the transceiver is in communication with each of the touch screens for receiving the patron's order from each of the touch screens. The transceiver is in wireless communication with a central computer system of the restaurant thereby facilitating restaurant employees to receive the patron's order.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to interactive table devices and more particularly pertains to a new interactive table device for remotely placing an order in a restaurant.

### (2) Description of Related Art Including Information Disclosed Under 37 CFR 1.97 and 1.98

The prior art relates to interactive table devices.

### BRIEF SUMMARY OF THE INVENTION

An embodiment of the disclosure meets the needs presented above by generally comprising a table that is positionable in a restaurant. A plurality of proximity sensors is provided and each of the proximity sensors is coupled to the table. Each of the proximity sensors is turned on when a patron moves within a trigger distance of the proximity sensors. A plurality of touch screens is each of the touch screens is coupled to the table. Each of the touch screens displays menu of the restaurant thereby facilitating the patron to order from the menu. A transceiver is coupled to the table and the transceiver is in communication with each of the touch screens for receiving the patron's order from each of the touch screens. The transceiver is in wireless communication with a central computer system of the restaurant thereby facilitating restaurant employees to receive the patron's order.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of an interactive restaurant table assembly according to an embodiment of the disclosure.

FIG. 2 is a top in-use view of an embodiment of the disclosure.

FIG. 3 is a bottom phantom view of an embodiment of the disclosure.

FIG. 4 is a front view of an embodiment of the disclosure.

FIG. 5 is a schematic view of an embodiment of the disclosure.

### DETAILED DESCRIPTION OF THE INVENTION

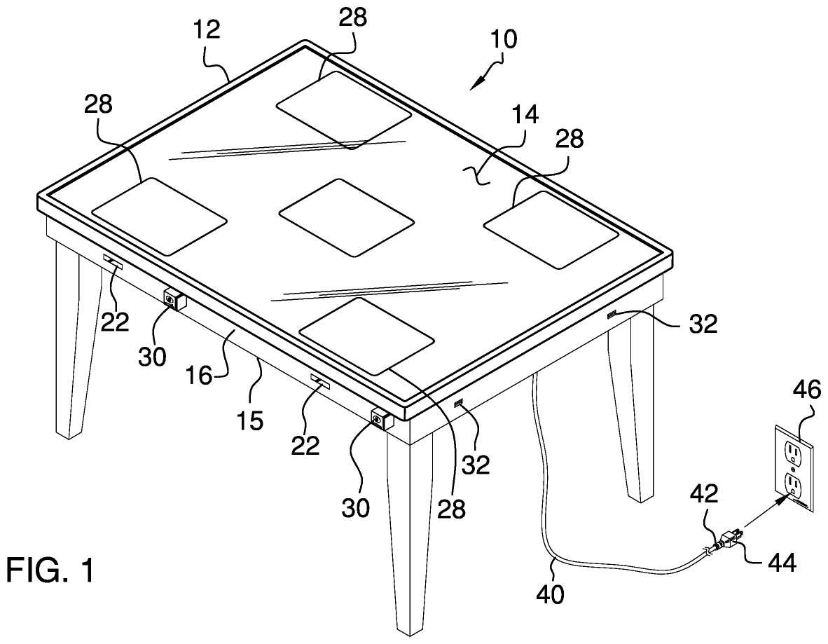

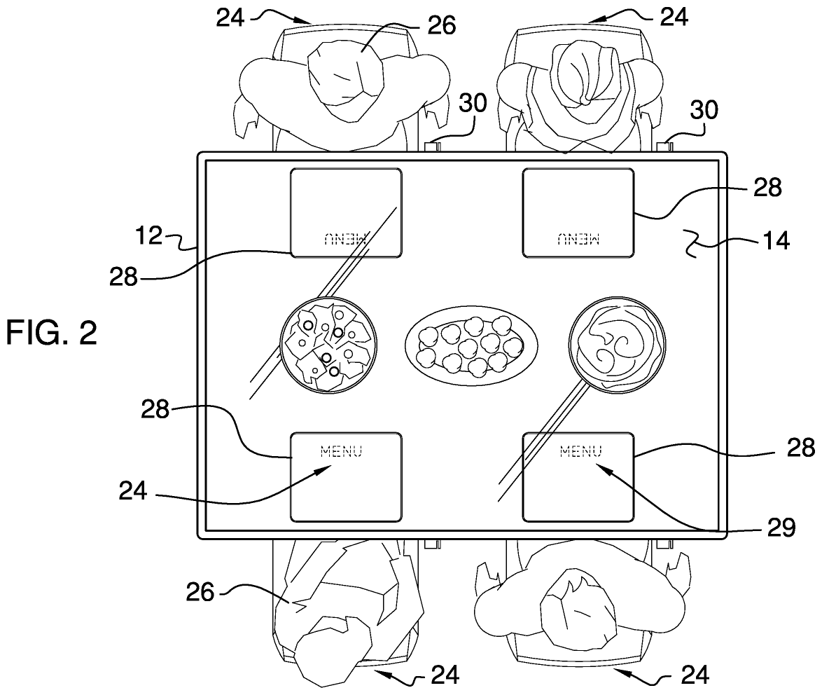

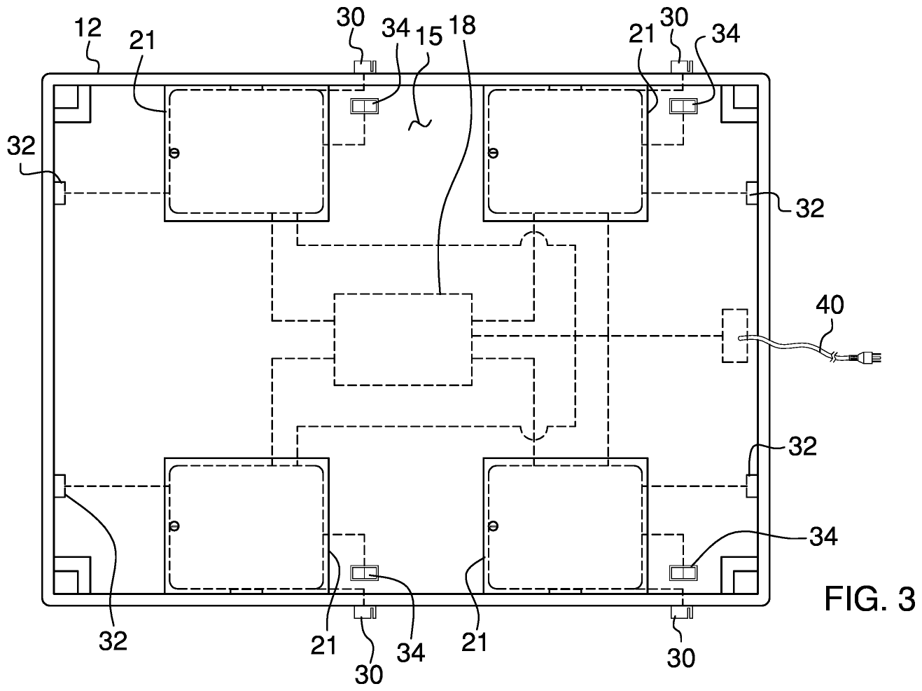

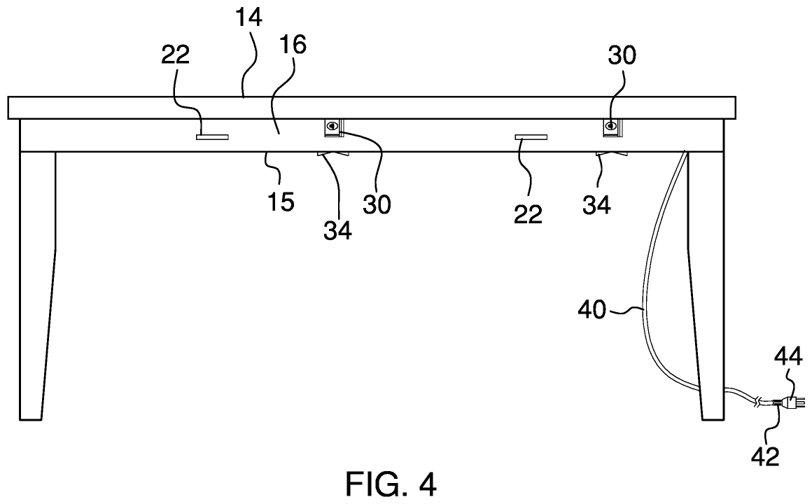

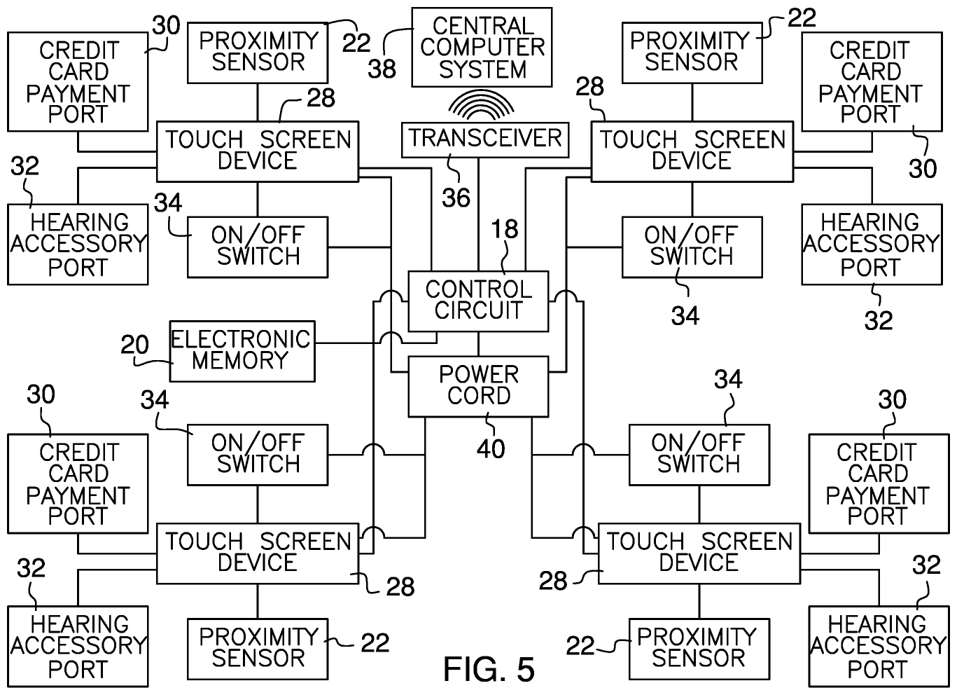

With reference now to the drawings, and in particular to FIGS. 1 through 5 thereof, a new interactive table device embodying the principles and concepts of an embodiment of the disclosure and generally designated by the reference numeral 10 will be described.

As best illustrated in FIGS. 1 through 5, the interactive restaurant table assembly 10 generally comprises a table 12 is positionable in a restaurant. The table 12 has a top surface 14, a bottom surface 15 and a perimeter edge 16. A control circuit 18 is coupled to the table 12 and the control circuit 18 receives a plurality of actuate inputs. An electronic memory 20 is coupled to the table 12 and the electronic memory 20 is electrically coupled to the control circuit 18. The electronic memory 20 stores a database comprising the menu of the restaurant and other information pertaining to placing a food order in the restaurant. A plurality of access panels 21 is each removably coupled to the bottom surface 15 of the table 12.

A plurality of proximity sensors 22 is provided and each of the proximity sensors 22 is coupled to the table 12. Each of the proximity sensors 22 is aligned with a respective one of a plurality of seating locations 24 around the table 12 and each of the proximity sensors 22 senses motion. In this way each of the proximity sensors 22 can sense a patron 26 sitting at the respective seating location. Each of the proximity sensors 22 is turned on when the patron 26 moves within a trigger distance, which may be less than approximately 5.0 feet, of the proximity sensors 22. Each of the proximity sensors 22 is electrically coupled to the control circuit 18 and each of the proximity sensors 22 has a respective one of the actuate inputs being associated therewith. The control circuit 18 receives an actuate input when the associated proximity sensor 22 senses the patron 26. Each of the proximity sensors 22 may comprise an electronic motion sensor, an infra-red sensor or any other electronic sensor that can sense the patron 26.

A plurality of touch screens 28 is provided and each of the touch screens 28 is coupled to the table 12. Each of the touch screens 28 is aligned with a respective one of the seating locations 24 around the table 12. In this way each of the touch screens 28 is visible to the patrons 26 sitting at the respective seating locations 24. Each of the touch screens 28 displays indicia 29 comprising a menu of the restaurant thereby facilitating the patron 26 to order from the menu. Additionally, each of the touch screens 28 is positioned on the top surface 14 of the table 12 thereby enhancing the patron 26's ability to interact with the touch screens 28. Each of the access panels 21 on the bottom surface 15 of the table 12 is aligned with a respective one of the touch screens 28 for servicing the respective touch screen 28.

Each of the touch screens 28 is electrically coupled to the control circuit 18 and each of the touch screens 28 has a respective one of the actuate inputs being associated therewith. Additionally, each of the touch screens 28 are turned on when the control circuit 18 receives the associated actuate input. Each of the touch screens 28 may comprise an LCD or other type of electronic touch screen. A plurality of card readers 30 is provided and each of the card readers 30 is coupled to the table 12. Each of the card readers 30 is electrically coupled to the control circuit 18 and each of the card readers 30 reads a credit card for payment processing.

A plurality of hearing ports 32 is each coupled to the table 12. Each of the hearing ports 32 may have a hearing aid plugged therein for assisting a hearing disabled patron 26. Each of the hearing ports 32 is aligned with a respective one of the seating locations 24 and each of the hearing ports 32 is electrically coupled to the control circuit 18. A plurality of power switches 34 is each coupled to the table 12 and each of the power switches 34 is aligned with a respective one of the seating locations 24 around the table 12. Each of the power switches 34 is electrically coupled to a respective one of the touch screens 28 and each of the power switches 34 turns the respective touch screen 28 on and off. Moreover, each of the power switches 34 is positioned on the bottom surface 15 of the table 12.

A transceiver 36 is provided and the transceiver 36 is coupled to the table 12. The transceiver 36 is in communication with each of the touch screens 28 for receiving the patron's 26 orders from the touch screens 28. Additionally, the transceiver 36 is in wireless communication with a central computer system 38 of the restaurant thereby facilitating restaurant employees to receive the patron's 26 orders. The transceiver 36 is electrically coupled to the control circuit 18 and the transceiver 36 may comprise a radio frequency transceiver or the like. Additionally, the transceiver 36 may employ a LAN signal for communicating with a computer network in the restaurant.

A power cord 40 is coupled to and extends away from the table 12. The power cord 40 is electrically coupled to the control circuit 18. The power cord 40 has a distal end 42 with respect to the table 12 and a male plug 44 is electrically coupled to the distal end 42. The male plug 44 engages a power source 46 comprising a female electrical outlet.

In use, the touch screen at each of the seating locations 24 is turned on when the proximity sensor 22 associated with the seating location 24 senses the patron 26. In this way the patron 26 can begin browsing the menu as soon as the patron 26 sits down. Additionally, the patron 26 can order from the menu on the touch screen 28. In this way the patron 26 can order without waiting for a server to take their order. Additionally, the patron 26 can pay for their order using the card readers 30 at the table 12. In this way the patron 26 can order food and pay for their food without having to wait for a server. Additionally, the transceiver 36 facilitates the patron 26's order to be immediately communicated to the kitchen to begin making the order.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An interactive restaurant table assembly being configured to facilitate restaurant patrons to remotely order food in a restaurant, said assembly comprising:
a table being positionable in a restaurant;
a plurality of proximity sensors, each of said proximity sensors being coupled to said table, each of said proximity sensors being aligned with a respective one of a plurality of seating locations around said table, each of said proximity sensors sensing motion wherein each of said proximity sensors is configured to sense a patron sitting at said respective seating location, each of said proximity sensors being turned on when a patron moves within a trigger distance of said proximity sensors;
a plurality of touch screens, each of said touch screens being coupled to said table, each of said touch screens being aligned with a respective one of said seating locations around said table wherein each of said touch screens is configured to be visible to the patron sitting at the respective seating location, each of said touch screens displaying indicia comprising a menu of the restaurant thereby facilitating the patron to order from the menu; and
a transceiver being coupled to said table, said transceiver being in communication with each of said touch screens for receiving the patron's order from each of said touch screens, said transceiver being in wireless communication with a central computer system of the restaurant thereby facilitating restaurant employees to receive the patron's order.

2. The assembly according to claim 1, further comprising:
a control circuit being coupled to said table, said control circuit receiving a plurality of actuate inputs; and
an electronic memory being coupled to said table, said electronic memory being electrically coupled to said control circuit, said electronic memory storing a database comprising the menu of the restaurant.

3. The assembly according to claim 2, wherein:
said table has a top surface and a perimeter edge;
each of said touch screens is positioned on said top surface of said table, each of said touch screens being electrically coupled to said control circuit, each of said touch screens having a respective one of said actuate inputs being associated therewith, each of said touch screens being turned on when said control circuit receives said associated actuate input.

4. The assembly according to claim 2, wherein each of said proximity sensors is electrically coupled to said control circuit, each of said proximity sensors has a respective one of said actuate inputs being associated therewith, said control circuit receiving said actuate input when said associated proximity sensor senses the patron.

5. The assembly according to claim 2, further comprising a plurality of card readers, each of said card readers being coupled to said table, each of said card readers being electrically coupled to said control circuit, each of said card readers reading a credit card for payment processing.

6. The assembly according to claim 2, further comprising a plurality of hearing ports, each of said hearing ports being coupled to said table wherein each of said hearing ports is configured to have a hearing aid plugged therein, each of said hearing ports being aligned with a respective one of said seating locations, each of said hearing ports being electrically coupled to said control circuit.

7. The assembly according to claim 3, further comprising a plurality of power switches, each of said power switches being coupled to said table, each of said power switches being aligned with a respective one of said seating locations around said table, each of said power switches being electrically coupled to a respective one of said touch screens, each of said power switches turning said respective touch screen on and off.

8. The assembly according to claim 2, further comprising a power cord being coupled to and extending away from said table, said power cord being electrically coupled to said control circuit, said power cord having a distal end with respect to said table, said distal end having a male plug being electrically coupled thereto, said male plug engaging a power source comprising a female electrical outlet.

9. An interactive restaurant table assembly being configured to facilitate restaurant patrons to remotely order food in a restaurant, said assembly comprising:
a table being positionable in a restaurant, said table having a top surface and a perimeter edge;
a control circuit being coupled to said table, said control circuit receiving a plurality of actuate inputs;
an electronic memory being coupled to said table, said electronic memory being electrically coupled to said control circuit, said electronic memory storing a database comprising the menu of the restaurant;
a plurality of proximity sensors, each of said proximity sensors being coupled to said table, each of said proximity sensors being aligned with a respective one of a plurality of seating locations around said table, each of said proximity sensors sensing motion wherein each of said proximity sensors is configured to sense a patron sitting at said respective seating location, each of said proximity sensors being turned on when a patron moves within a trigger distance of said proximity sensors, each of said proximity sensors being electrically coupled to said control circuit, each of said proximity sensors having a respective one of said actuate inputs being associated therewith, said control circuit receiving said actuate input when said associated proximity sensor senses the patron;
a plurality of touch screens, each of said touch screens being coupled to said table, each of said touch screens being aligned with a respective one of said seating locations around said table wherein each of said touch screens is configured to be visible to the patron sitting at the respective seating location, each of said touch screens displaying indicia comprising a menu of the restaurant thereby facilitating the patron to order from the menu, each of said touch screens being positioned on said top surface of said table, each of said touch screens being electrically coupled to said control circuit, each of said touch screens having a respective one of said actuate inputs being associated therewith, each of said touch screens being turned on when said control circuit receives said associated actuate input;
a plurality of card readers, each of said card readers being coupled to said table, each of said card readers being electrically coupled to said control circuit, each of said card readers reading a credit card for payment processing;
a plurality of hearing ports, each of said hearing ports being coupled to said table wherein each of said hearing ports is configured to have a hearing aid plugged therein, each of said hearing ports being aligned with a respective one of said seating locations, each of said hearing ports being electrically coupled to said control circuit;
a plurality of power switches, each of said power switches being coupled to said table, each of said power switches being aligned with a respective one of said seating locations around said table, each of said power switches being electrically coupled to a respective one of said touch screens, each of said power switches turning said respective touch screen on and off;
a transceiver being coupled to said table, said transceiver being in communication with each of said touch screens for receiving the patron's order from each of said touch screens, said transceiver being in wireless communication with a central computer system of the restaurant thereby facilitating restaurant employees to receive the patron's order, said transceiver being electrically coupled to said control circuit; and
a power cord being coupled to and extending away from said table, said power cord being electrically coupled to said control circuit, said power cord having a distal end with respect to said table, said distal end having a male plug being electrically coupled thereto, said male plug engaging a power source comprising a female electrical outlet.
